(19) United States
(12) Patent Application Publication
(10) Pub. No.: US 2012/0250115 A1
(43) Pub. Date: Oct. 4, 2012

(54) DOCUMENT READING DEVICE, METHOD FOR CONTROLLING THE SAME, AND IMAGE FORMING DEVICE

(75) Inventor: Hideyuki UMENO, Sagamihara-shi (JP)

(73) Assignee: Konica Minolta Business Technologies, Inc., Tokyo (JP)

(21) Appl. No.: 13/436,347

(22) Filed: Mar. 30, 2012

(30) Foreign Application Priority Data
Apr. 1, 2011 (JP) 2011-082073
Mar. 2, 2012 (JP) 2012-046446

(51) Int. Cl. H04N 1/04

(52) U.S. Cl. 358/498

(57) ABSTRACT

In a document reading device, a saddle-stitched document is opened a paper feed tray in a saddle-stitched state. A first reader and a second reader respectively read a front surface and a back surface of the document along a route of transfer. A notifying unit notifies of a manner how the saddle-stitch document is to be opened to be placed on paper feed tray. A reconstructing unit reconstructs images respectively for pages of the saddle-stitch document read by first reader and second reader by rearranging an order of the images.

This application is based on Japanese Patent Applications Nos. 2011-082073 and 2012-046446 filed with the Japan Patent Office on Apr. 1, 2011 and on Mar. 2, 2012, respectively, the entire content of which is hereby incorporated by reference.

### BACKGROUND OF THE INVENTION

1. Field of the Invention

The present invention relates to document reading devices, methods for controlling the same, and image forming devices, and in particular, to a document reading device for reading images of a saddle-stitched document, a method for controlling the same, and an image forming device.

2. Description of the Related Art

Conventionally, various techniques for reading images of a saddle-stitched document have been proposed. A saddle-stitched document or a saddle-stitch document refers to a document having images printed thereon such that a plurality of paper leaves folded in the middle are formed into a booklet or a brochure by binding along the folding margin as a binding margin, and contents for two pages are printed on either side of each leaf.

For instance, Document 1 (Japanese Laid-Open Patent Publication No. 2010-119063) discloses a technique for unbinding a document in saddle-stitch printing by removing staples, setting leaves of the document on an ADF (Auto Document Feeder), reading images of the leaves, and laying out data of the read images as shown in the document. According to this technique described in the publication, information such as how many leaves are to be read and whether the document is to be left-hand/right-hand is inputted and accepted in association with the read images. Further, according to this technique, a preview of an image on a first leaf of the document that has been read is displayed, and a user is caused to select how many leaves are to be read and whether a plane from which the reading of the saddle-stitch document is started is a plane of a front cover/back cover or a plane therebetween.

However, the conventional technique requires cumbersome work of unbinding the document by removing the staples and then setting the unbound document on the ADF in order to have the saddle-stitched document read. In particular, there is a problem that the leaves in the document after the staples for saddle-stitching have been removed cannot be bound again using a common stapler that the user most likely owns. There is also a problem that with a method of opening the saddle-stitched document without unbinding and placing at a read position on a platen glass to read, it is necessary to repeat the reading more than once, which is cumbersome.

### SUMMARY OF THE INVENTION

The present invention has been contrived in view of the above circumstances, and aims to facilitate reading of a saddle-stitched document using an ADF.

A document reading device according to the present invention is provided with: a paper feed tray for placing a saddle-stitched document thereon in a saddle-stitched state; a transferring unit for transferring the document from the paper feed tray; a first reader for reading a front surface of the document along a route of transfer through when the transferring unit transfers the document; a second reader for reading a back surface of the document along the route of transfer; a notifying unit for notifying of a manner how the saddle-stitch document is to be opened to be placed on the paper feed tray; a storage unit for storing images of each page of the saddle-stitch document read by the first reader and the second reader; and a reconstructing unit for reconstructing the images stored in the storage unit by rearranging an order of the images.

Preferably, the document reading device is further provided with: an acquiring unit for acquiring either a total number of leaves or a total number of pages included in the saddle-stitch document; and a counter for counting the number of transfer times of the saddle-stitch document through the route of transfer. The notifying unit updates and notifies of the manner how the saddle-stitch document being transferred through the route of transfer is to be opened based on the total number of leaves or the total number of pages acquired by the acquiring unit and the number of transfer times counted by the counter.

Preferably, the document reading device is further provided with: a paper feed roller for feeding the document to the route of transfer; a separation roller, having a separation function of separating sheets of document one by one, for nipping the document with the paper feed roller; and a separation roller controller for controlling the separation roller. The separation roller controller is capable of controlling in one of a single-sheet mode and a saddle-stitching mode, the single-sheet mode being for transferring a single-sheet document through the route of transfer, the saddle-stitching mode being for transferring the saddle-stitch document through the route of transfer, activates the separation function of the separation roller in the single-sheet mode, and deactivates the separation function of the separation roller in the saddle-stitching mode.

More preferably, the document reading device is further provided with: a separation roller driver for driving the separation roller; and a driver switch for switching a rotational direction transmitted from the separation roller driver to the separation roller. The separation roller controller controls the driver switch such that in the single-sheet mode, the separation roller rotates in a direction opposite of a direction for sending the document to the route of transfer, and in the saddle-stitching mode, the separation roller rotates in the direction for sending the document to the route of transfer.

More preferably, the document reading device is further provided with: a separation roller driver for driving the separation roller; and a blocking unit for blocking transmission of driving force from the separation roller driver to the separation roller. The separation roller controller controls the blocking unit such that in the single-sheet mode, the separation roller is driven by the separation roller driver, and in the saddle-stitching mode, the separation roller is prevented from being driven by the separation roller driver.

Preferably, the document reading device is further provided with: a registration unit, provided along the route of transfer, for transferring the document with timing; and a registration unit controller for controlling the registration unit. The registration unit controller is capable of controlling in one of a single-sheet mode and a saddle-stitching mode, the single-sheet mode being for transferring a single-sheet document through the route of transfer, the saddle-stitching mode being for transferring the saddle-stitch document through the route of transfer, causes the registration unit to temporarily stop the document when transferring the document in the single-sheet mode, and causes the registration unit to be prevented from temporarily stopping the document when transferring the document in the saddle-stitching mode.

Preferably, the route of transfer includes: a first route to send the document in a first direction; and a second route provided downstream from the first route, and to send the document in a second direction that is opposite of the first direction. The first reader and the second reader read the document along the second route. The document reading device is further provided with: an additional tray for sending the document to the second route without passing through the first route; and a controller for controlling in one of a single-sheet mode and a saddle-stitching mode, the single-sheet mode being for transferring a single-sheet document through the route of transfer, the saddle-stitching mode being for transferring the saddle-stitch document through the route of transfer. The controller transfers the document so that the document passes through the first route and the second route in the single-sheet mode, and transfers the document so that the document passes through the second route from the additional tray in the saddle-stitching mode.

Preferably, the document reading device is further provided with: a pickup roller for feeding the document placed on the paper feed tray to the route of transfer; a transfer mechanism having a rotating body provided on the paper feed tray so as to face the pickup roller; and a transfer controller for controlling the transfer mechanism. The transfer controller is capable of controlling in one of a single-sheet mode and a saddle-stitching mode, the single-sheet mode being for transferring a single-sheet document through the route of transfer, the saddle-stitching mode being for transferring the saddle-stitch document through the route of transfer, maintains the transfer mechanism in a stopped state in the single-sheet mode, and drives the transfer mechanism in a transfer direction in the saddle-stitching mode.

Preferably, the document reading device is further provided with: at least one pair of rollers provided along the route of transfer; and a roller driver for driving both of the pair of rollers to rotate in a document transfer direction.

An image forming device according to the present invention is provided with the document reading device as described above.

A method according to the present invention is a method, executed by a computer, of controlling a document reading device including: a storage unit; a paper feed tray for placing a saddle-stitched document thereon in a saddle-stitched state; a transferring unit for transferring the document from the paper feed tray; a first reader and a second reader for respectively reading a front surface and a back surface of a document along a route of transfer through which the transferring unit transfers the document. This method is provided with the steps of: notifying of a manner how the saddle-stitch document is to be opened to be placed on the paper feed tray; storing images of each page of the saddle-stitch document read by the first reader and the second reader in the storage unit; and reconstructing the images stored in the storage unit by rearranging an order of the images, the images respectively being of pages of the saddle-stitch document.

Preferably, the method of controlling is further provided with the steps of: acquiring either a total number of leaves or a total number of pages included in the saddle-stitch document; and counting the number of transfer times of the saddle-stitch document through the route of transfer. In the notifying, the manner how the saddle-stitch document being transferred through the route of transfer is to be opened is updated and notified based on the total number of leaves or the total number of pages as well as on the number of transfer times.

Preferably, the document reading device further includes: a paper feed roller for feeding the document to the route of transfer; and a separation roller having a separation function of separating sheets of document one by one and to nip the document with the paper feed roller. The method of controlling is further provided with the step of controlling an operation of the separation roller depending on a type of the document sent through the route of transfer. In the controlling of the operation of the separation roller, the separation function of the separation roller is activated in a single-sheet mode for sending a single-sheet document along the route of transfer, and the separation function of the separation roller is deactivated in a saddle-stitching mode for sending a saddle-stitch document along the route of transfer.

More preferably, the document reading device further includes: a separation roller driver for driving the separation roller; and a driver switch for switching a rotational direction transmitted from the separation roller driver to the separation roller. In the controlling of the operation of the separation roller, the driver switch is controlled such that the separation roller in the single-sheet mode rotates in a direction opposite of a direction for sending the document to the route of transfer, and the separation roller in the saddle-stitching mode rotates in the direction for sending the document to the route of transfer.

More preferably, the document reading device further includes: a separation roller driver for driving the separation roller; and a blocking unit for blocking transmission of driving force from the separation roller driver to the separation roller. In the controlling of the operation of the separation roller, the blocking unit is controlled such that the separation roller in the single-sheet mode is driven by the separation roller driver, and the separation roller in the saddle-stitching mode is prevented from being driven by the separation roller driver.

Preferably, the document reading device further includes: a registration unit provided along the route of transfer, for transferring the document with timing. The method of controlling is further provided with the step of controlling an operation of the separation roller depending on a type of the document sent through the route of transfer. In the controlling of the operation of the separation roller, the registration unit is caused to temporarily stop the document when transferring the document in a single-sheet mode for sending a single-sheet document along the route of transfer, and the registration unit is prevented from stopping the document when transferring the document in a saddle-stitching mode for sending a saddle-stitch document along the route of transfer.

Preferably, the route of transfer includes a first route to send the document in a first direction; and a second route provided downstream from the first route and to send the document in a second direction that is opposite of the first direction. The first reader and the second reader read the document along the second route. The document reading device further includes an additional tray to send the document to the second route without passing through the first route. The method is further provided with the step of controlling a transfer mode of the document depending on a type of the document sent through the route of transfer. In the controlling of the transfer mode, the document is transferred so that the document passes through the first route and the second route in a single-sheet mode for sending a single-sheet document along the route of transfer, and the document is transferred so that the document passes through the second route from the additional tray in a saddle-stitching mode for sending a saddle-stitch document along the route of transfer.

Preferably, the document reading device further includes: a pickup roller for feeding the document placed on the paper feed tray to the route of transfer; and a transfer mechanism having a rotating body provided on the paper feed tray so as to face the pickup roller. The method is further provided with the step of controlling the transfer mechanism depending on a type of the document sent through the route of transfer. In the controlling of the transfer mechanism, the transfer mechanism is maintained in a stopped state in a single-sheet mode for sending a single-sheet document along the route of transfer, and the transfer mechanism is driven in a transfer direction in a saddle-stitching mode for sending a saddle-stitch document along the route of transfer.

Preferably, the document reading device further includes: at least one pair of rollers provided along the route of transfer. The method of controlling is further provided with the step of driving both of the pair of rollers to rotate in a document transfer direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a specific example of a device configuration of a document reading device according to this embodiment.

FIG. 2 is a block diagram illustrating a specific example of a control configuration of the document reading device shown in FIG. 1.

FIGS. 3 to 8 are views for illustration of reconstruction of images read from a saddle-stitch document in the document reading device shown in FIG. 1.

FIG. 9 is an enlarged view of the document reading device shown in FIG. 1 focusing a portion near a tray.

FIG. 10 illustrates how rollers are driven when a document is sent out to a transfer route near the tray of the document reading device shown in FIG. 1.

FIG. 11 is an enlarged view of the document reading device shown in FIG. 1 focusing a portion near the tray.

FIG. 12 is a flowchart of a document reading process executed in the document reading device shown in FIG. 1.

FIG. 13 illustrates one example of a screen shown in a display panel in the document reading process.

FIG. 14 illustrates another example of the screen shown in the display panel in the document reading process.

FIGS. 15 to 17 are views for illustration of operations of the rollers in the document reading device shown in FIG. 1.

FIG. 18 is a block diagram illustrating a specific example of a control configuration of a modified example of the document reading device shown in FIG. 1.

FIG. 19 is a flowchart of a modified example of, a document transfer process shown in FIG. 12.

FIG. 20 illustrates a modified example of the document reading device shown in FIG. 1.

FIG. 21 illustrates one example of an image forming device according to the present invention.

### DESCRIPTION OF THE PREFERRED EMBODIMENTS

An embodiment of the present invention will be now described with reference to the drawings. In the following description, like components are denoted by like reference symbols. Like names and functions are also used for these components. Therefore, detailed descriptions for these components will not be repeated.

### Device Configuration

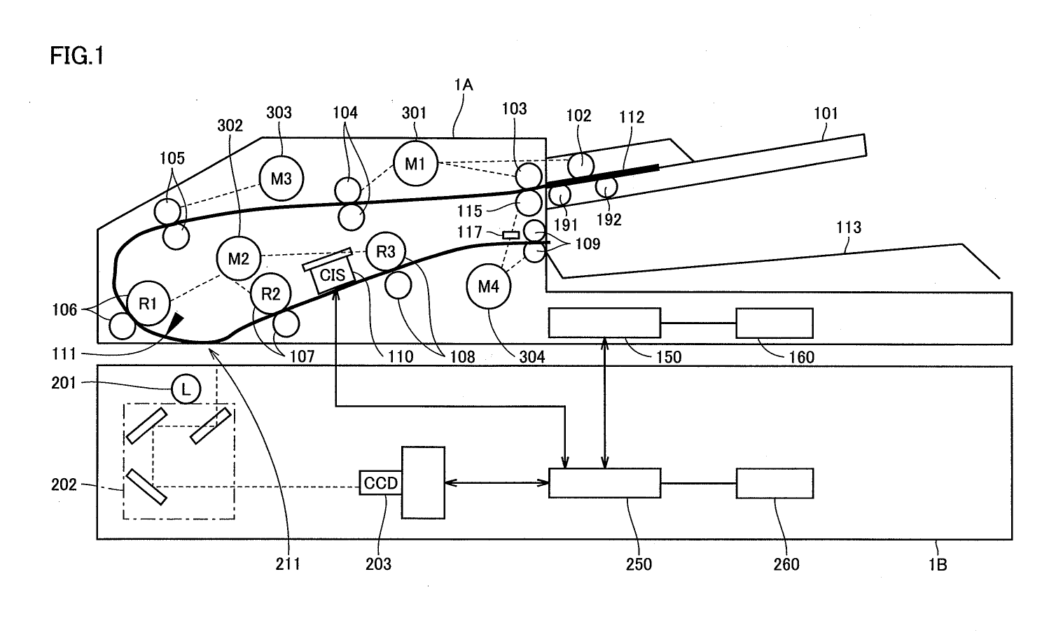

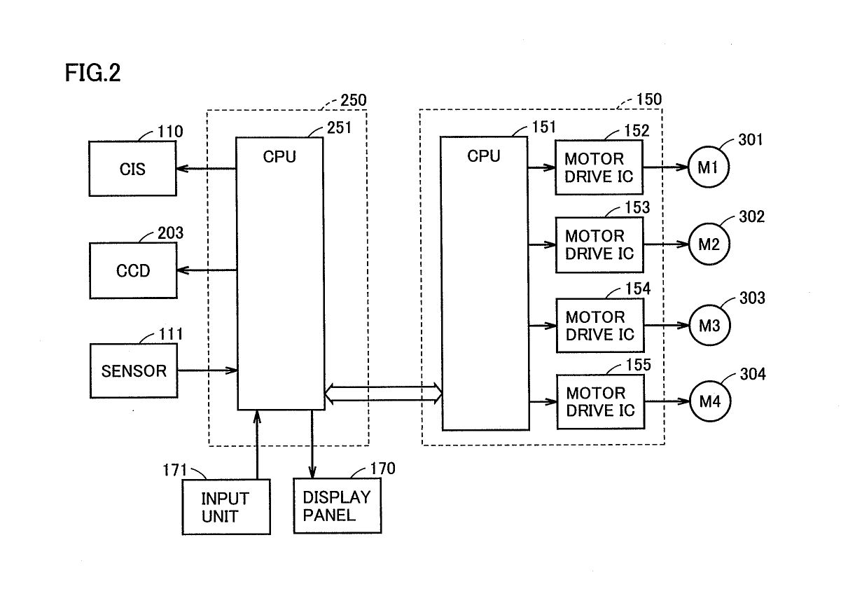

FIG. 1 illustrates a specific example of a device configuration of a document reading device according to this embodiment. FIG. 2 is a block diagram illustrating a specific example of a control configuration of the document reading device according to this embodiment.

Referring to FIGS. 1 and 2, the document reading device according to the embodiment includes a sheet-through ADF (Auto Document Feeder) unit 1A and a reader unit 1B.

ADF unit 1A sends a document to a read position 211 at which one side of the document is read by reader unit 1B, and sends the document to a reader 110 provided within ADF unit 1A and for reading the other side of the document.

ADF unit 1A is provided with a tray 101 for containing the document to be fed, and a tray 113 for receiving the document that has been fed, and a transfer route for a document is provided between tray 101 and tray 113.

In a boundary area between tray 101 and the transfer route, a pickup roller 102, a paper feed roller 103, and a separation roller 115 are provided. A document stack 112 on tray 101 is fed by pickup roller 102, and a single document sheet is separated from the document stack by paper feed roller 103 and separation roller 115 and sent to the transfer route.

In the following description, a tray 101 side of a transfer direction along the transfer route, that is, a direction from tray 101 toward tray 113 is also referred to as an “upstream side in the transfer direction”, and a tray 113 side of this direction is also referred to as a “downstream side in the transfer direction”. Alternatively, the upstream side of the transfer route is also referred as “front”, and the downstream side of the transfer route is also referred as “back”.

A pair of intermediate rollers 104 and a pair of registration rollers 105 are provided along the transfer direction. Both pairs sandwich the transfer route. The document that has been transferred to registration rollers 105 along the transfer route by intermediate rollers 104 is subjected to skew correction by registration rollers 105, as shown in FIG. 16. In FIG. 16, R21 to R23 indicate rotational directions of pickup roller 102, paper feed roller 103, separation roller 115, and intermediate rollers 104, respectively. Then, the document after the skew correction is further transferred to read position 211 of reader unit 1B.

In the transfer route, a pair of read rollers 106 and a pair of read rollers 107 are provided respectively on the upstream side and the downstream side of a portion corresponding to read position 211 of reader unit 1B. Due to rotation of the roller pairs, the transferred document is further transferred downstream passing through read position 211 of reader unit 1B. With this, a side of the document facing reader unit 1B is read by reader unit 1B. In the following description, the side of the transferred document facing reader unit 1B is also referred to as a “front surface” and the other side of the document is also referred to as a “back surface”.

Reader 110 is provided along the transfer route on the further downstream side from read rollers 107. Reader 110 includes an imaging unit facing the back surface of the transferred document. A pair of read rollers 108 are provided on the downstream side from reader 110. Due to rotation of read rollers 107 and 108, the transferred document is further transferred downstream passing through reader 110.

One example of reader 110 provided within ADF unit 1A is a reader employing a CIS (Contact Image Sensor). Specifically, reader 110 includes a light source that is not depicted and a CMOS (Complementary Metal Oxide Semiconductor) sensor that are positioned facing the back surface of the transferred document. A part of light applied from the light source is reflected on a side that faces the light source of the document to pass through the read position and received by the CMOS sensor, and light reception signals R, G, and B are converted into RGB data. With this, the back surface of the document is read by reader 110. Reader 110 is electrically connected to a control device 250 of reader unit 1B that will be later described, and outputs the RGB data as a reading result to control device 250. In the following description, reader 110 is also referred to as CIS 110. Further, in the following description, read rollers 106, 107, and 108 are also referred to as an R1 roller, an R2 roller, an R3 roller, respectively.

In a boundary area between the transfer route and tray 113, paper exit rollers 109 are provided. Due to rotation of paper exit rollers 109, the transferred document whose back surface has been read by CIS 110 exits to tray 113.

ADF unit 1A is further provided with a paper feed motor 301, a read motor 302, a registration motor 303, and a paper exit motor 304, as motors driving the rollers. In the following description, paper feed motor 301, read motor 302, registration motor 303, and paper exit motor 304 are also referred to as motors M1, M2, M3, and M4.

Paper feed motor 301 is connected to pickup roller 102 and paper feed roller 103 via an undepicted paper feed clutch, and drives these rollers.

Paper feed motor 301 is also connected to one of the pair of intermediate rollers 104 and drives the roller, and the other of intermediate rollers 104 rotates following the driven roller.

Registration motor 303 is connected to one of the pair of registration rollers 105 and drives the roller, and the other of registration rollers 105 rotates following the driven roller.

Read motor 302 is connected to one of the pair of read rollers 106, one of the pair of read rollers 107, and one of the pair of read rollers 108, and drives these rollers. The other of each pair of read rollers 106, 107, or 108 rotates following the corresponding driven roller.

Paper exit motor 304 is connected to one of the pair of paper exit rollers 109 and drives the roller. The other of paper exit rollers 109 rotates following the driven one of paper exit rollers 109.

Paper exit motor 304 is also connected to separation roller 115 via a rotational direction switching mechanism 117. Further, separation roller 115 includes an undepicted torque limiter, and is provided with a separation function of feeding a document sheet one by one.

The torque limiter is an undepicted tubular component that couples separation roller 115 to its driving shaft. When the torque of separation roller 115 is lower than the setting, that is, when only a single document sheet is sandwiched between paper feed roller 103 and separation roller 115, the driving shaft and separation roller 115 are decoupled and separation roller 115 rotates following paper feed roller 103. By contrast, when the torque of separation roller 115 is higher than the setting, that is, when more than one document sheet is sandwiched between paper feed roller 103 and separation roller 115, the driving shaft and separation roller 115 are coupled and separation roller 115 rotates in a direction sending the document sheets backward instead of following paper feed roller 103.

A sensor 111 for detecting the presence of the document is provided at any position along the transfer route. The position at which sensor 111 is provided is preferably located on the upstream side of read position 211, and an example is a position near read rollers 106 (the downstream side of read rollers 106 in FIG. 1).

As another example, the sensor can be located on the upstream side of read rollers 106. Examples of sensor 111 include a transmissive sensor. Sensor 111 is electrically connected to control device 250 of reader unit 1B that will be later described, and outputs a sensor signal to control device 250 when there is a document present within a range of detection.

ADF unit 1A is further provided with a control device 150 and a memory 160. A CPU 151 (Central Processing Unit) included in control device 150 reads and executes a program stored in memory 160. Each of motors M1 to M4 is electrically connected to control device 150, and controls the rotation according to a control signal from control device 150.

Reader unit 1B, for example, includes a CCD (Charged Coupled Device). In this case, reader unit 1B is provided with an exposure lamp (L) 201, a mirror group 202 including a plurality of mirrors, a CCD sensor 203 as the reader, control device 250, and memory 260.

Upon passing of the document through read position 211, exposure lamp (L) 201 applies the front surface of the document. The light produced by the applied light reflecting on the front surface of the document is reflected on mirror group 202, directed to CCD sensor 203, and received by CCD sensor 203.

Control device 250 includes a CPU 251, and serves as an image processor by reading and executing a program stored in memory 260. CCD sensor 203 performs photoelectric conversion of a received signal into RGB data, and outputs the RGB data to control device 250. Control device 250 serving as an image processor generates image data based on the RGB data outputted from CIS 110 and CCD sensor 203, and causes memory 260 to store the generated image data.

At a portion near paper feed roller 103 of tray 101, drums 191 and 192 are provided.

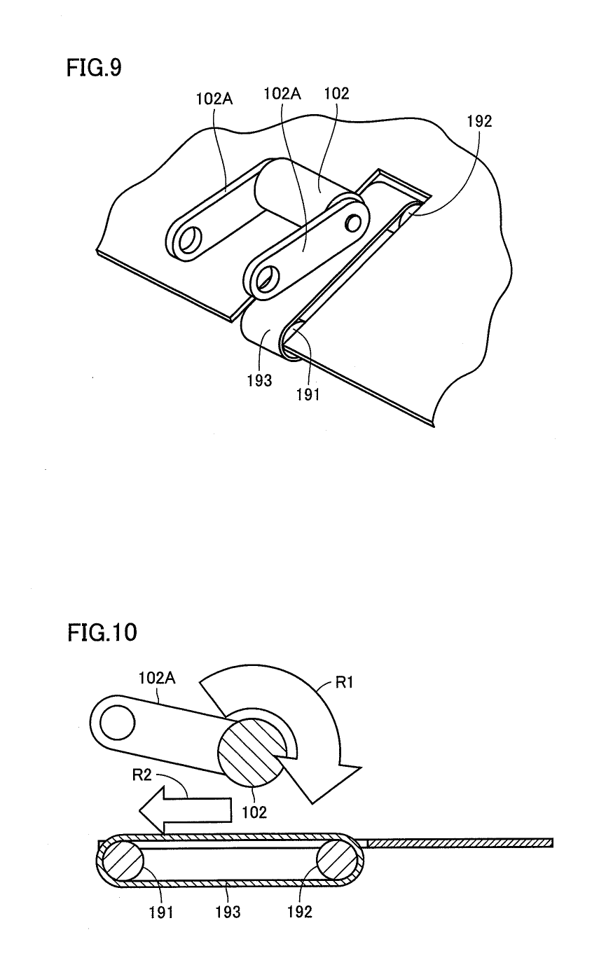

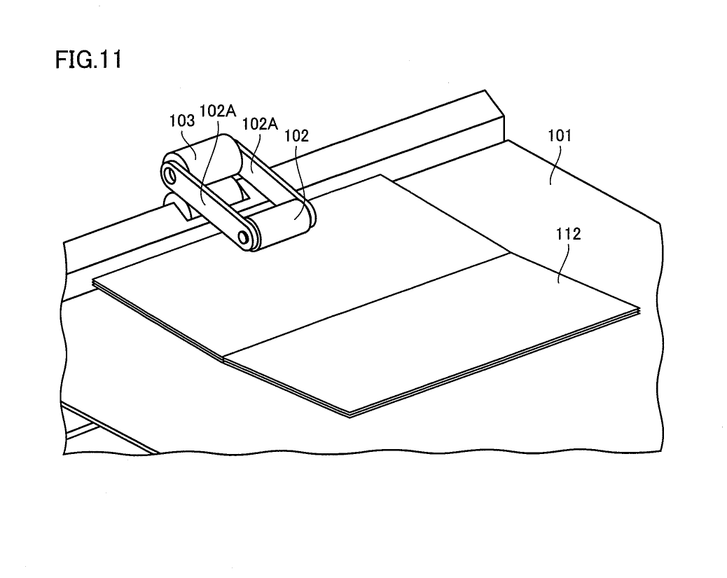

FIG. 9 is an enlarged view of the document reading device shown in FIG. 1 focusing a portion near tray 101. Further, FIG. 10 illustrates how the rollers are driven when the document is sent out to the transfer route near tray 101. Moreover, FIG. 11 is an enlarged view of the document reading device shown in FIG. 1 focusing the portion near tray 101.

Referring further to FIGS. 9 to 11, tray 101 is provided with a belt 193 at a position slightly above a paper feed plane of tray 101. Belt 193 is suspended between drum 191 and drum 192. Further, FIGS. 9 and 10 illustrate supporting unit 102A that supports pickup roller 102.

Pickup roller 102 rotates in a direction indicated by an arrow R1 in order to send the document to the transfer route.

As will be described later, operation modes of the document reading device according to this embodiment include a single-sheet document mode in which reading of a single-sheet document is performed and a saddle-stitched document mode in which reading of a saddle-stitched document is performed.

In the operation in the saddle-stitched document mode, belt 193 rotates at the same time as pickup roller 102 in a direction of transferring a document (indicated by an arrow R2) so as to send a saddle-stitched document to the transfer route smoothly. By contrast, in the single-sheet document mode, belt 193 does not rotate and remains unmoved. This is because the rotation of belt 193 when reading a single-sheet document is envisaged to damage this document. Belt 193 rotates as drums 191 and 192 are caused to rotate by the driving of the undepicted motor. Preferably, belt 193 is made of a material that can generate a predetermined degree of friction with the document, such as rubber material. Instead of belt 193, a roller whose surface in contact with the document is made of the material as described above can also be provided. However, providing the belt increases an area of contact with the document, and whereby the document can be sent to the transfer route more reliably.

Rotational operations of pickup roller 102 and belt 193 (drums 191 and 192) thus configured are controlled by CPU 151.

Referring to FIG. 2, control device 150 of ADF unit 1A includes CPU 151 and executes the program stored in memory 160, and control device 250 of reader unit 1B includes CPU 251 and executes the program stored in memory 260. CPU 151 of ADF unit 1A and CPU 251 of reader unit 1B are electrically connected, and communicate control information, such as information on the size of the document, the operation mode, and timing information for reading the document, with each other.

CPU 151 of ADF unit 1A is connected to a motor drive IC 152 for driving paper feed motor (M1) 301, a motor drive IC153 for driving read motor (M2) 302, a motor drive IC154 for driving registration motor (M3) 303, and a motor drive IC155 for driving paper exit motor (M4) 304. CPU 151 inputs an excitation signal to motor drive IC, thereby controlling the rotation of the motor.

CPU 251 of reader unit 1B is connected to a sensor 111, and a sensor signal is inputted from sensor 111. CPU 251 of reader unit 1B is further connected to CIS 110 and CCD sensor 203. By executing a process that will be described later, CPU 251 determines a position of the document along the transfer route based on the sensor signal from sensor 111, and determines timing of reading by CIS 110 and CCD sensor 203 using the determined position. Further, CPU 251 controls the timing of reading by CIS 110 and CCD sensor 203.

As used herein, CCD sensor 203 is referred to as a first reader, and CIS 110 is referred to as a second reader, as needed.

Further, CPU 251 of reader unit 1B serves as an image processor by reading and executing the program stored in memory 260. CPU 251 as an image processor accepts an input of RGB data from CIS 110 and an input of RGB data from CCD sensor 203, processes the inputted RGB data to generate image data, and causes memory 260 to store the generated image data.

Moreover, as described above, the document reading device is provided with the motor for driving drums 191 and 192. CPU 151 drives this motor accordingly by means of a driving circuit.

Furthermore, the document reading device includes a display panel 170 configured by such as a liquid crystal display device and an input unit 171 configured by such as various buttons. When input unit 171 is operated, information corresponding to this operation is inputted to CPU 251. Further, CPU 251 controls a display mode of display panel 170. In this embodiment, input unit 171 is realized as software keys displayed in display panel 170. Specifically, according to this embodiment, the document reading device is provided with a touch panel as one example of display panel 170 and input unit 171.

### Reading and Reconstructing Saddle-Stitch Document

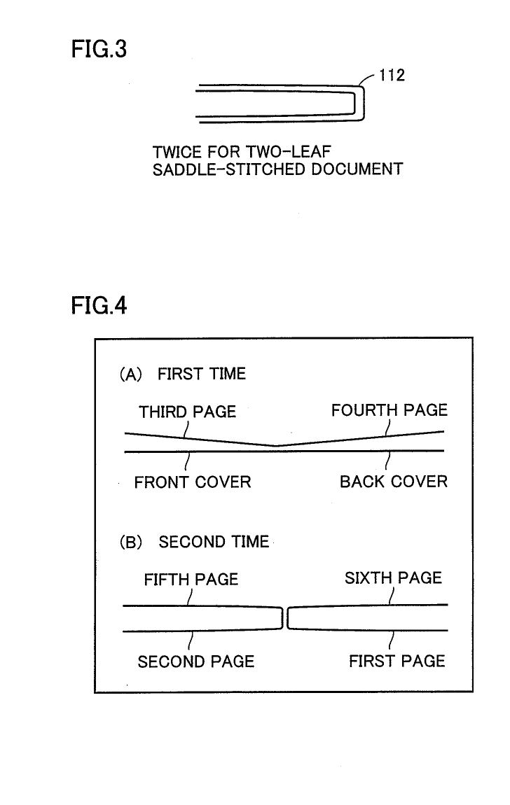

A program for reconstructing images read from a saddle-stitch document is now described with reference to FIGS. 3 to 8. Such a program is stored in memory 260, and executed by CPU 251. As used herein, the reconstruction refers to an operation of reading image data for all leaves included in a saddle-stitch document, each leaf having an image for two pages on either side, having the read image data be stored in memory 260, and causing CPU 251 to rearrange images for the respective pages stored in memory 260 in order to allow browsing or printing.

When a user desires to have the document reading device read images of document 112 including two leaves that are saddle-stitched as shown in FIG. 3, for example, the user sets document 112 on tray 101 as shown in (A) of FIG. 4 such that a third page and a fourth page of this document face up and a front cover and a back cover of this document face down. Document 112 is then transferred through the transfer route and subjected to a first reading. Next, the user sets document 112 on tray 101 as shown in (B) of FIG. 4 such that a fifth page and a sixth page of this document face up and a second page and a first page of this document face down. Document 112 is then transferred through the transfer route and subjected to a second reading.

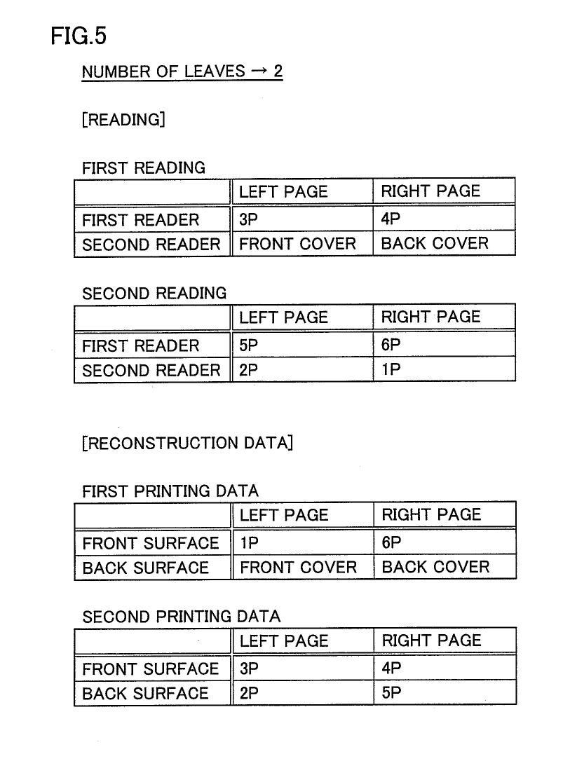

FIG. 5 shows a table of page number correspondence, for a document of two leaves, used for reconstructing image data that are read by the first reader and the second reader, and constituting a part of the program stored in memory 260. In “Reading” table, there are shown the page numbers corresponding to the images that are read by the first reader and the second reader respectively in the first reading and the second reading.

In “Reconstruction Data” table in FIG. 5, there is shown arrangements of the image data corresponding to the page numbers after the images are reconstructed. According to the image data thus reconstructed, for a first printing paper, an image for the first page and an image for the sixth page are respectively formed (printed) on the left hand and the right hand of the front surface, and an image for the front cover and an image for the back cover are respectively formed (printed) on the left hand and the right hand of the back surface. Further, for a second printing paper, an image for the third page and an image for the fourth page are respectively formed (printed) on the left hand and the right hand of the front surface, and an image for the second page and an image for the fifth page are respectively formed (printed) on the left hand and the right hand of the back surface.

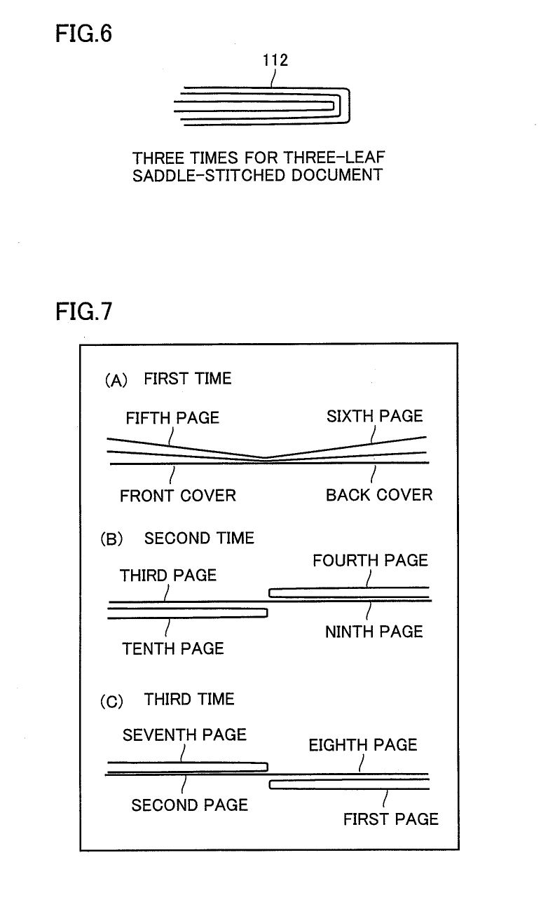

When a user desires to have the document reading device read images of document 112 including three leaves that are saddle-stitched as shown in FIG. 6, for example, the user sets document 112 on tray 101 as shown in (A) of FIG. 7 such that a fifth page and a sixth page of this document face up and a front cover and a back cover of this document face down. Document 112 is then transferred through the transfer route and subjected to the first reading. Next, the user sets document 112 on tray 101 as shown in (B) of FIG. 7 such that a third page and a fourth page of this document face up and a tenth page and a ninth page of this document face down. Document 112 is then transferred through the transfer route and subjected to the second reading. Next, the user sets document 112 on tray 101 as shown in (C) of FIG. 7 such that a seventh page and an eighth page of this document face up and a second page and a first page of this document face down. Document 112 is then transferred through the transfer route and subjected to a third reading.

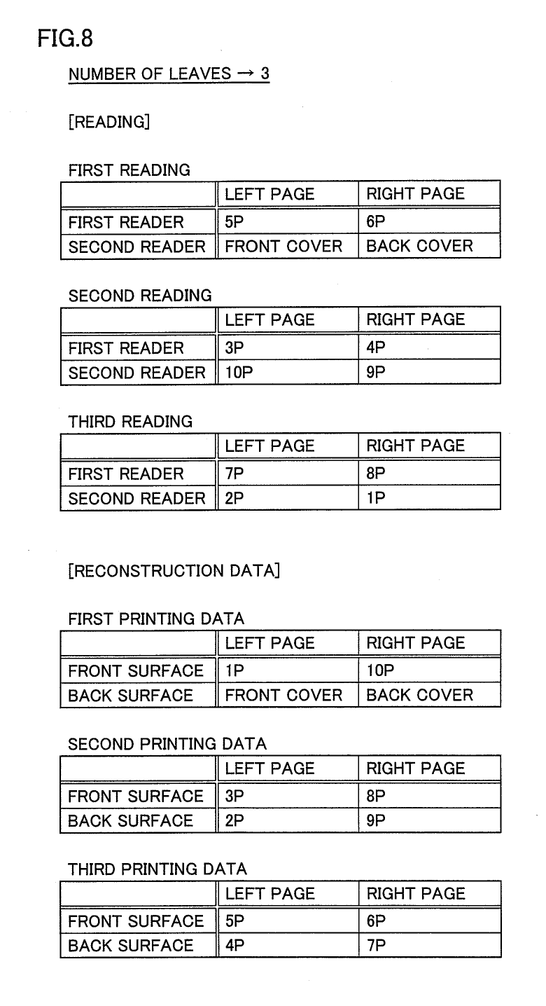

FIG. 8 shows a table of page number correspondence, for a document of three leaves, used for reconstructing image data that are read by the first reader and the second reader, and constituting a part of the program stored in memory 260. In “Reading” table, there are shown the page numbers corresponding to the images that are read by the first reader and the second reader respectively in the first reading to the third reading.

In “Reconstruction Data” table in FIG. 8, there is shown arrangements of the image data corresponding to the page numbers after the images are reconstructed in order to have the images be printed on printing papers. According to the image data thus reconstructed, for a first printing paper, an image for the first page and an image for the tenth page are respectively formed (printed) on the left hand and the right hand of the front surface, and an image for the front cover and an image for the back cover are respectively formed (printed) on the left hand and the right hand of the back surface. Further, for a second printing paper, an image for the third page and an image for the eighth page are respectively formed (printed) on the left hand and the right hand of the front surface, and an image for the second page and an image for the ninth page are respectively formed (printed) on the left hand and the right hand of the back surface. Moreover, for a third printing paper, an image for the fifth page and an image for the sixth page are respectively formed (printed) on the left hand and the right hand of the front surface, and an image for the fourth page and an image for the seventh page are respectively formed (printed) on the left hand and the right hand of the back surface.

Memory 260 stores the program so that the reconstruction is performed in different manners depending on the number of leaves saddle-stitched in the document as described above with reference to FIGS. 3 to 8.

According to the document reading device, an input of information specifying the number of leaves saddle-stitched in the document in the saddle-stitched document mode is accepted through input unit 171. Based on this number, CPU 251 performs the reconstruction of the images for the pages of the document stored in memory 260. The number of leaves saddle-stitched in the document is not limited to two or three, and can be any number that is more than one. Alternatively, a total page number including the front cover and the back cover can be inputted instead of the information specifying the number of leaves.

### Document Reading Process

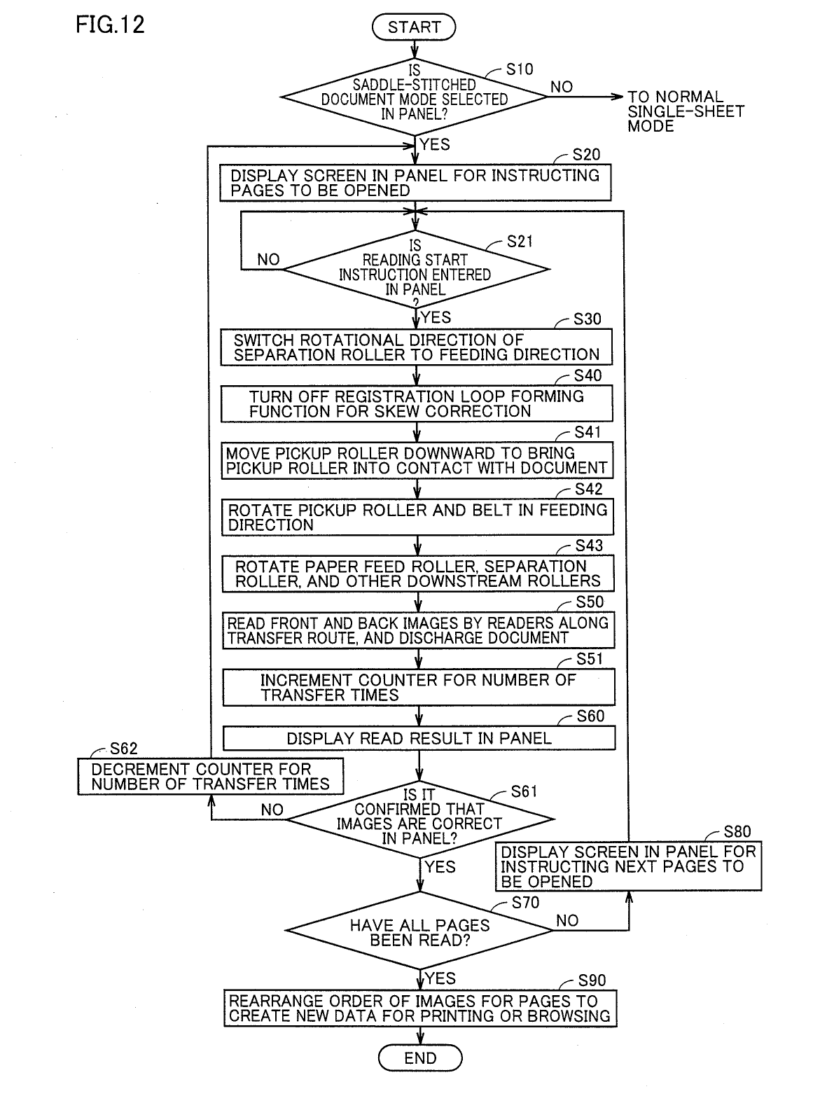

FIG. 12 is a flowchart of a document reading process executed in the document reading device according to this embodiment. The document reading process is executed by CPU 251 and CPU 151 in conjunction with each other.

Referring to FIG. 12, in Step S10, CPU 251 determines whether or not the saddle-stitched document mode has been selected by touch operation of display panel 170. If it is determined that the saddle-stitched document mode has been selected, the process proceeds to Step S20. By contrast, if it is determined that the single-sheet document mode has been selected instead of the saddle-stitched document mode, CPU 251 executes a reading process of images of a document in the single-sheet document mode. The reading process of images of a document in the single-sheet document mode can be executed using a known technique, and therefore not described herein.

In Step S20, CPU 251 displays information for specifying pages to be opened in display panel 170, and the process proceeds to Step S21.

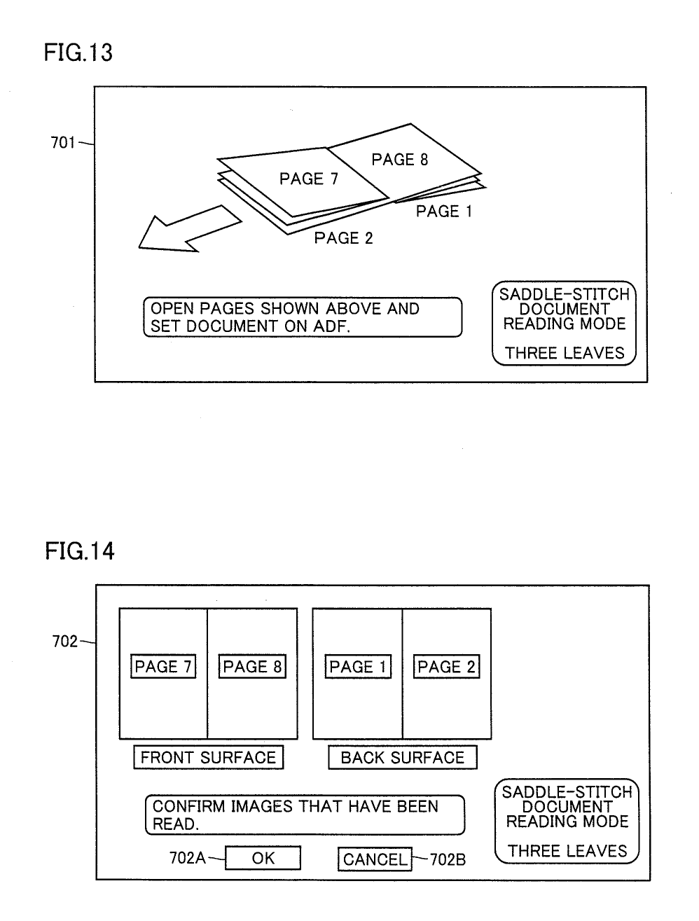

FIG. 13 illustrates one example of how a screen is shown in display panel 170.

A screen 701 in FIG. 13 illustrates how the saddle-stitch document is to be opened and set on tray 101. Specifically, the screen shows an image for specifying the pages of the document to be opened. Screen 701 also shows, in addition to the manner how the document is to be opened, the number of leaves saddle-stitched in the document whose images are to be read. CPU 251 accepts the input of the information specifying the number of saddle-stitched leaves, for example, after Step S10 and before carrying out Step S20. The information specifying the number of saddle-stitched leaves can be stored in memory 260 by default. In this case, the input of the above information can be accepted only when it is necessary to alter the stored number of leaves (when information indicating that the alteration is necessary is inputted to input unit 171). Alternatively, a total page number including the front cover and the back cover can be inputted instead of the information specifying the number of leaves.

The screen showing how the document is to be opened is displayed in display panel 170 also in Step S80 that will be later described, in addition to Step S20. The content to be displayed, that is, how the document is to be opened, varies depending on the number of saddle-stitched leaves and how many times the reading has been performed. Specifically, display panel 170 displays how the saddle-stitch document set on tray 101 is to be opened based on the number of saddle-stitched leaves and the number of transfer times.

For example, if the number of leaves saddle-stitched in the document is two, it is displayed such that the pages shown in the field for the “first reader” face up, and the pages shown in the field for the “second reader” face down according to the number of reading times in “Reading” table shown in FIG. 5.

If the number of leaves saddle-stitched in the document is three, it is displayed such that the pages shown in the field for the “first reader” face up, and the pages shown in the field for the “second reader” face down according to the number of reading times in “Reading” table shown in FIG. 8.

The number of leaves saddle-stitched in the document is not limited to two or three, and can be any number that is more than one.

CPU 251 acquires display content (screen data) indicating how the document is to be opened from memory 260 based on the number of leaves in the document and the number of reading times and displays the acquired data in display panel 170.

Referring back to FIG. 12, in Step S21, CPU 251 determines whether or not information to start reading the saddle-stitch document is inputted via input unit 171 of display panel 170. If it is determined that the information has been inputted, the process proceeds to Step S30. By contrast, if it is determined that the information has not been inputted, the process is suspended in Step S21.

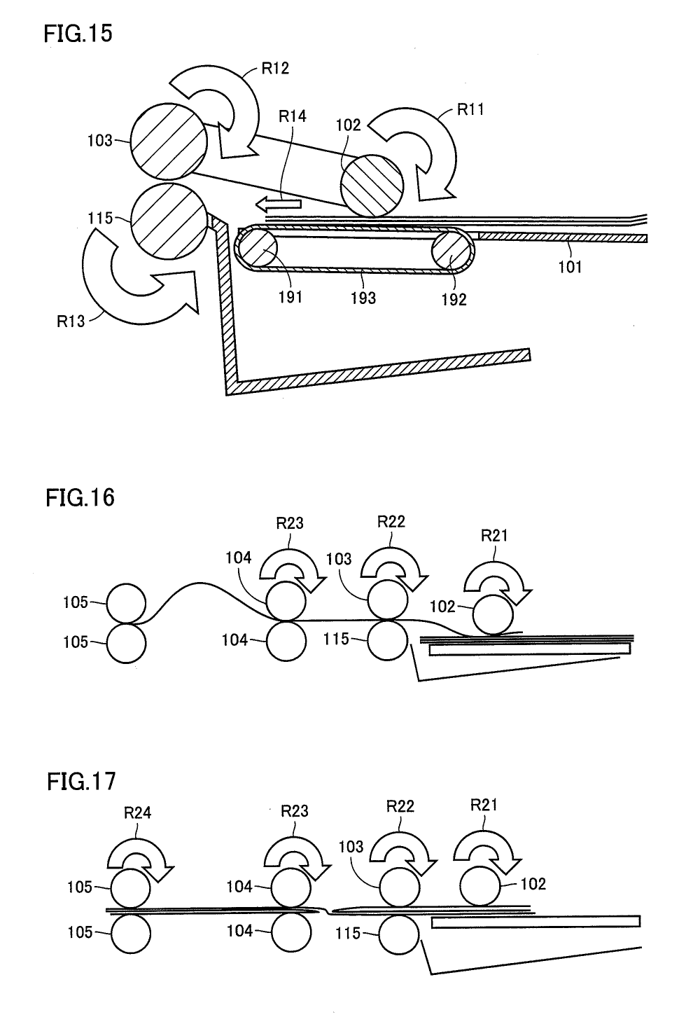

According to this embodiment, separation roller 115 including the torque limiter is driven to rotate in a direction opposite of the document transfer direction in the single-sheet document mode, and separation roller 115 is driven to rotate in the document transfer direction in the saddle-stitched document mode. In Step S30, rotational direction switching mechanism 117 switches so that separation roller 115 rotates in the document transfer direction. With this, as shown in FIG. 15, separation roller 115 rotates in the direction in which the document is sent to the transfer route, similarly to paper feed roller 103, in transferring the document in Step S43.

In Step S40, CPU 151 turns off the skew correction. As a result, the skew correction by registration rollers 105 (FIG. 16) that is performed when transferring the document in the single-sheet document mode is not performed in the saddle-stitched document mode. This is to prevent the front end of the saddle-stitched document from being damaged by temporarily stopping at registration rollers 105 when a loop is formed by the rotation of intermediate rollers 104. In the saddle-stitched document mode, as shown in FIG. 17, registration rollers 105 does not make a temporary stop too, and rotates so as to transfer the document at the same timing as intermediate rollers 104 and the like. A reference symbol R24 indicates the rotational direction of registration rollers 105.

Next, in Step S41, as shown in FIG. 15, CPU 151 moves pickup roller 102 downward such that belt 193 is brought into pressure contact with pickup roller 102, and the process proceeds to Step S42.

In Step S42, CPU 151 starts feeding the document by rotating belt 193 along with pickup roller 102 in the direction for sending the document to the transfer route, and the process proceeds to Step S43.

In Step S43, CPU 151 starts transferring the document by rotating paper feed roller 103, separation roller 115, and other rollers on the downstream side along the document transfer direction, and the process proceeds to Step S50. Separation roller 115 rotates in the direction for transferring the document as shown in FIG. 15.

Next, in Step S50, CPU 151 and CPU 251 drive the rollers along the transfer route to transfer the document, the images on the front side and the back side of the document are read by the first reader and the second reader along the transfer route, memory 260 is caused to store the read images, and the document is discharged onto tray 113. Then, the process proceeds to Step S51.

In Step S51, CPU 251 increments the number of a counter by one, thereby incrementing the number of reading times by the first reader and the second reader to the document to be processed, that is, the number of transfer times, and the process proceeds to Step S60.

In Step S60, CPU 251 displays the images that have been read in Step S50 in display panel 170. FIG. 14 illustrates one example of the screen shown at this time. A screen 702 in FIG. 14 includes the images that have been read as the front surface and the back surface, an OK button 702A, and a cancel button 702B. As shown by such as “page 7” and “page 8” in the figure, screen 702 shows page information indicating pages to which the read images respectively correspond, along with the images that have been read.

Then, the process proceeds to Step S61. In Step S61, CPU 251 determines whether or not an operation to confirm that the images are correct has been made to input unit 171, that is, whether a touching operation has been made to OK button 702A or to cancel button 702B. If it is determined that the touching operation has been made to OK button 702A and that it has been confirmed that the images are correct, the process proceeds to Step S70. By contrast, if it is determined that the touching operation has been made to cancel button 702B and that it has been confirmed that the images are not correct, the process proceeds to Step S62, and the number of transfer times is decremented by one. Then, the process returns to Step S20.

In Step S70, CPU 251 determines whether or not all of the pages in the saddle-stitch document to be processed have been read. The above determination is made by determining whether or not the transfer has been performed by the number of transfer times to be performed according to the number of saddle-stitched leaves, for example. If it is determined that all of the pages in the saddle-stitch document to be processed have been read, the process proceeds to Step S90. By contrast, if it is determined that not all of the pages in the saddle-stitch document to be processed have been read, the process proceeds to Step S80.

In Step S80, CPU 251 displays a screen showing how the document is to be opened for the next reading in display panel 170, and the process returns to Step S21.

Further, in Step S90, the images that have been acquired through plural times of reading in the process from Steps S10 to S80 are reconstructed in memory 260 to generate electronic data for printing or browsing, and the document reading process is terminated.

According to this embodiment as described above, various adjustments are made in the saddle-stitched document mode, such as turning off a registration loop forming function, in order to prevent the document from being damaged. This eliminates an adverse effect envisaged in particular for a device configured to read images on both front and back sides at the same time as much as possible without unbinding the saddle-stitch document.

### Modified Example (1)

Next, a modified example (1) of the above described embodiment will be described.

According to modified example (1), there is provided a clutch for blocking transmission of driving force from motor 304 to separation roller 115, instead of rotational direction switching mechanism 117 for switching the rotational direction of separation roller 115.

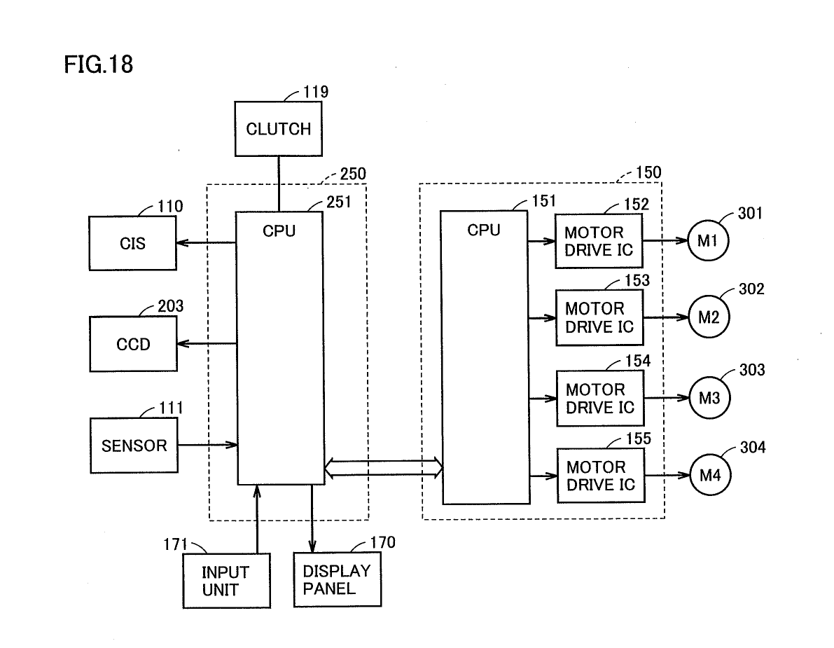

FIG. 18 is a block diagram illustrating a specific example of a control configuration of the document reading device according to this modified example. FIG. 18 shows the block diagram including a clutch 119 in addition to the block diagram shown in FIG. 2. Clutch 119 is for blocking the transmission of the driving force from motor 304 to separation roller 115.

In the saddle-stitched document mode, separation roller 115 and motor 304 are decoupled by clutch 119, and the driving force from motor 304 is not transmitted to separation roller 115, and separation roller 115 always rotates following paper feed roller 103. It is also possible to keep motor 304 turned off so as not to drive separation roller 115, thereby causing separation roller 115 to rotate following paper feed roller 103 without providing clutch 119.

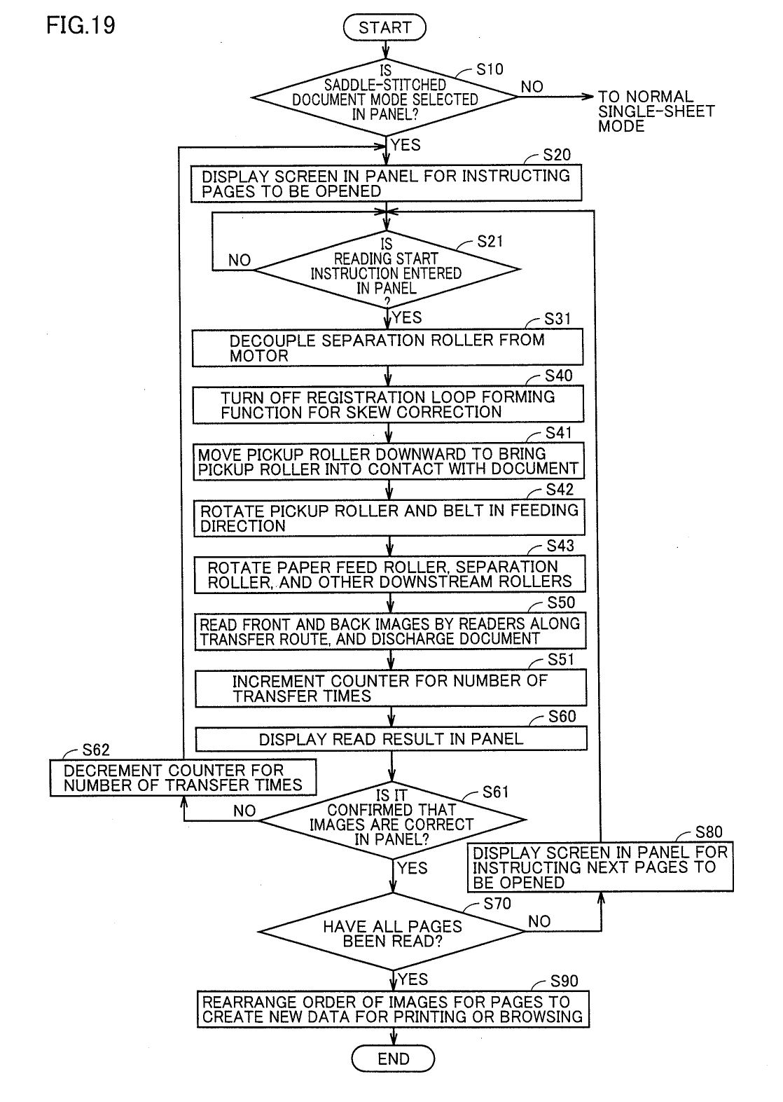

FIG. 19 is a flowchart of a document transfer process of this modified example.

Referring to FIG. 19, this modified example is different in that Step S31 is provided instead of Step S30 as compared to the flowchart shown in FIG. 12. As the steps of the same numbers as in the flowchart of FIG. 12 are the same as FIG. 12, only the step different from the flowchart of FIG. 12 will be described.

In this modified example, upon reception of the input of the information to start reading the saddle-stitch document from input unit 171 in Step S21 after displaying the screen in Step S20, in Step S31, CPU 251 turns clutch 119 on to decouple separation roller 115 and motor 304. Then, the process proceeds to Step S40.

### Modified Example (2)

Next, a modified example (2) will be described.

Modified example (2) is different from the previous embodiment in that both of each pair of rollers are driven, instead of configuring the pairs of rollers such that one of each pair of rollers is driven and whereby the other roller rotates following the driven roller. Specifically, paper feed motor 301 is connected to both of the pair of intermediate rollers 104, registration motor 303 is connected to both of the pair of registration rollers 105, read motor 302 is connected to both of the pairs of read rollers 106, 107, and 108, and paper exit motor 304 is connected to both of the pair of paper exit rollers 109. Each motor drives both of the corresponding pair of rollers in the document transfer direction.

As this allows the document to be transferred with stronger force, it is possible to transfer the document reliably also in the saddle-stitched document mode in which more than one leaves are transferred.

### Modified Example (3)

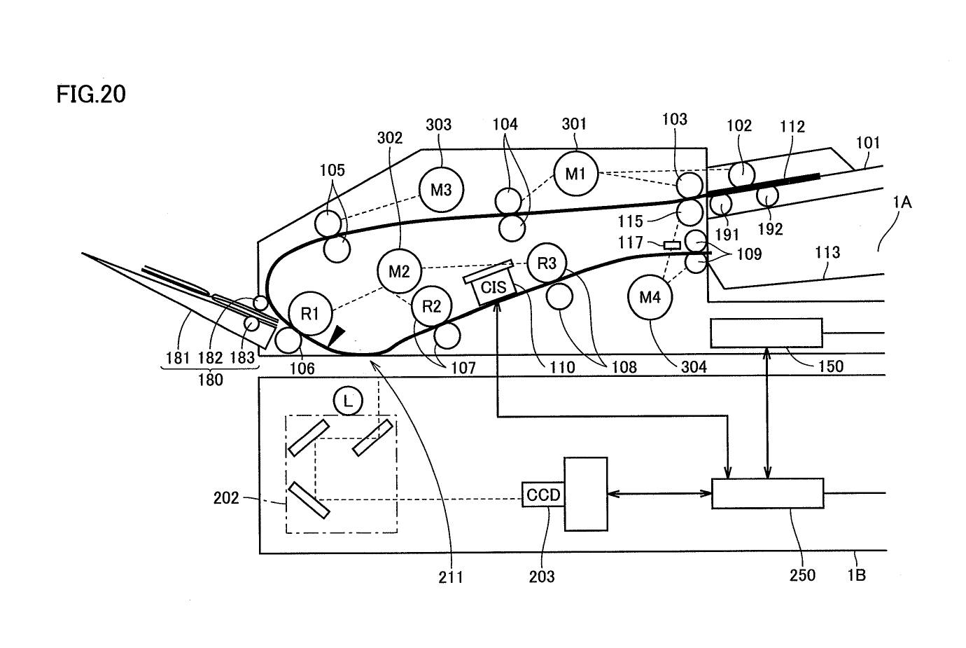

FIG. 20 illustrates a modified example (3).

A device shown in FIG. 20 is provided with an additional tray unit 180 in addition to the configuration of the device shown in FIG. 1. Additional tray unit 180 includes a tray 181, rollers 182, and 183.

Rollers 182 and 183 send the document set on tray 181 to read rollers 106. The document sent from tray 181 to read rollers 106 passes through read rollers 107, read roller 108, and paper exit rollers 109, and exits to tray 113. In this transfer route, the direction for transferring the document is always directed toward right in the figure.

According to this modified example (3), the document is transferred, in the single-sheet document mode, along the transfer route that passes through pickup roller 102 and paper feed roller 103, and to tray 113 from tray 101. In this transfer route, the document is first transferred toward left, and then redirected to right during the transfer. The document set on the right hand of the device exits on the right hand of the device. Accordingly, it is possible to reduce a moving distance as much as possible for the user who has set the document to receive the discharged document.

By contrast, the transfer direction of the document is not redirected along the transfer route along which the document is transferred from to tray 181 to read rollers 107. Accordingly, it is possible to reduce the load on the document as compared to the transfer route that changes the transfer direction in the middle of the transfer. According to this modified example (3), the document is transferred, in the saddle-stitched document mode, along the transfer route that passes from tray 181 to read rollers 107.

### Modified Example (4)

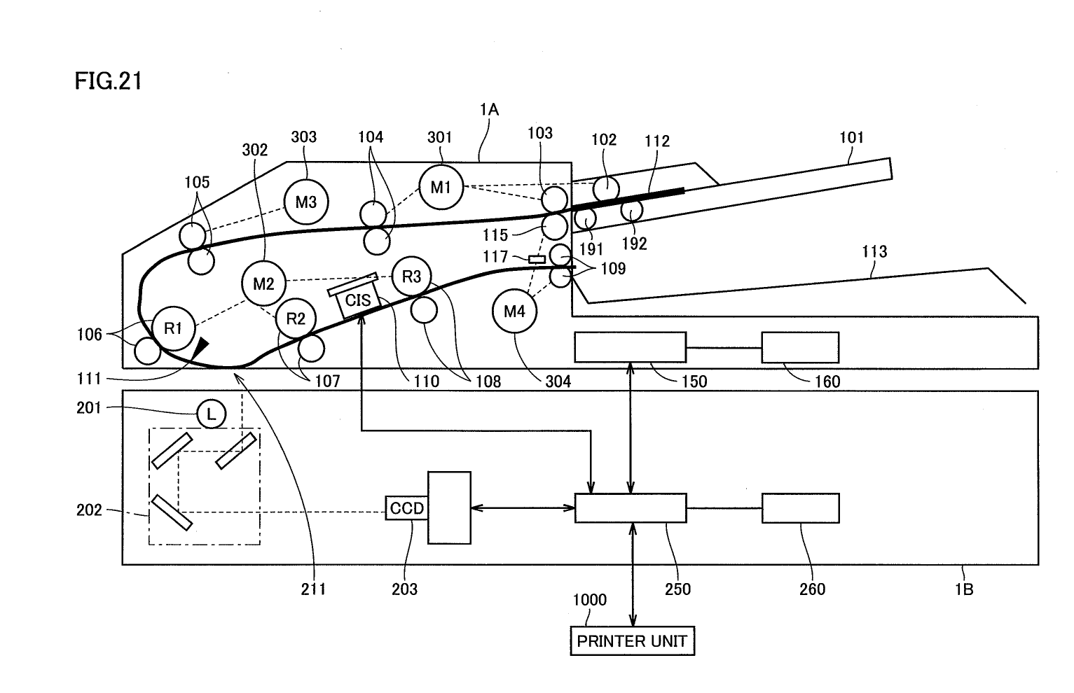

FIG. 21 illustrates one example of an image forming device according to the present invention.

Connecting an image reading device as described above to printer unit 1000 realizes an image forming device for forming the images that the image reading device has generated by the printer unit.

Examples of the image forming device according to the present invention include a copying machine, a printer, a scanner, a facsimile machine, and a multifunction peripheral (MFP) having functions of two or more of these apparatuses. Similarly to an image forming function provided for a general-purpose printer, printer unit 1000 has a function of forming (printing) the images generated (acquired) by the image reading device on a recording medium such as printing paper.

According to this embodiment as described above, a first side of a saddle-stitch document is read by a first reader, a second side of the saddle-stitch document is read by a second reader, and the images of the document are rearranged in order of the pages in the saddle-stitch document based on the number of leaves acquired by acquiring means and how the document is opened.

Therefore, it is possible for the user to acquire the images rearranged in order of the pages in the saddle-stitch document, without unbinding the saddle-stitch document, at fewer times of setting the document in the saddle-stitched state on the ADF as compared to the number of times of setting the document on the platen glass spreading each page.

This facilitates reading of the saddle-stitched document.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A document reading device, comprising:
a paper feed tray for placing a saddle-stitched document thereon in a saddle-stitched state;
a transferring unit for transferring the document from said paper feed tray;
a first reader for reading a front surface of the document along a route of transfer through which said transferring unit transfers the document;
a second reader for reading a back surface of the document along said route of transfer;
a notifying unit for notifying of a manner how the saddle-stitch document is to be opened to be placed on said paper feed tray;
a storage unit for storing images of each page of the saddle-stitch document read by said first reader and said second reader; and
a reconstructing unit for reconstructing the images stored in said storage unit by rearranging an order of the images.

2. The document reading device according to claim 1, further comprising:
an acquiring unit for acquiring either a total number of leaves or a total number of pages included in said saddle-stitch document; and
a counter for counting the number of transfer times of said saddle-stitch document through said route of transfer, wherein
said notifying unit updates and notifies of the manner how the saddle-stitch document being transferred through said route of transfer is to be opened based on the total number of leaves or the total number of pages acquired by said acquiring unit and the number of transfer times counted by said counter.

3. The document reading device according to claim 1, further comprising:
a paper feed roller for feeding the document to said route of transfer;
a separation roller having a separation function of separating sheets of document one by one, and to nip the document with said paper feed roller; and
a separation roller controller for controlling said separation roller, wherein
said separation roller controller
is capable of controlling in one of a single-sheet mode and a saddle-stitching mode, the single-sheet mode being for transferring a single-sheet document through said route of transfer, the saddle-stitching mode being for transferring the saddle-stitch document through said route of transfer,
activates the separation function of said separation roller in said single-sheet mode, and
deactivates the separation function of said separation roller in said saddle-stitching mode.

4. The document reading device according to claim 3, further comprising:
a separation roller driver for driving said separation roller; and
a driver switch for switching a rotational direction transmitted from said separation roller driver to said separation roller, wherein
said separation roller controller controls said driver switch such that
in said single-sheet mode, said separation roller rotates in a direction opposite of a direction for sending the document to said route of transfer, and
in said saddle-stitching mode, said separation roller rotates in the direction for sending the document to said route of transfer.

5. The document reading device according to claim 3, further comprising:
a separation roller driver for driving said separation roller; and
a blocking unit for blocking transmission of driving force from said separation roller driver to said separation roller, wherein
said separation roller controller controls said blocking unit such that
in said single-sheet mode, said separation roller is driven by said separation roller driver, and
in said saddle-stitching mode, said separation roller is prevented from being driven by said separation roller driver.

6. The document reading device according to claim 1, further comprising:
a registration unit, provided along said route of transfer, for transferring the document with timing; and
a registration unit controller for controlling said registration unit, wherein
said registration unit controller
is capable of controlling in one of a single-sheet mode and a saddle-stitching mode, the single-sheet mode being for transferring a single-sheet document through said route of transfer, the saddle-stitching mode being for transferring the saddle-stitch document through said route of transfer,
causes said registration unit to temporarily stop the document when transferring the document in said single-sheet mode, and
causes said registration unit to be prevented from temporarily stopping the document when transferring the document in said saddle-stitching mode.

7. The document reading device according to claim 1, said route of transfer including a first route to send the document in a first direction, and a second route provided downstream from said first route and to send the document in a second direction that is opposite of said first direction, said first reader and said second reader reading the document along said second route, the document reading device further comprising:
an additional tray for sending said document to said second route without passing through said first route; and
a controller for controlling in one of a single-sheet mode and a saddle-stitching mode is further provided, the single-sheet mode being for transferring a single-sheet document through said route of transfer, the saddle-stitching mode being for transferring the saddle-stitch document through said route of transfer, wherein
said controller
transfers the document so that the document passes through said first route and said second route in said single-sheet mode, and
transfers the document so that the document passes through said second route from said additional tray in said saddle-stitching mode.

8. The document reading device according to claim 1, further comprising:
a pickup roller for feeding the document placed on said paper feed tray to said route of transfer;
a transfer mechanism having a rotating body provided on said paper feed tray so as to face said pickup roller; and
a transfer controller for controlling said transfer mechanism, wherein
said transfer controller
is capable of controlling in one of a single-sheet mode and a saddle-stitching mode, the single-sheet mode being for transferring a single-sheet document through said route of transfer, the saddle-stitching mode being for transferring the saddle-stitch document through said route of transfer,
maintains said transfer mechanism in a stopped state in said single-sheet mode, and
drives said transfer mechanism in a transfer direction in said saddle-stitching mode.

9. The document reading device according to claim 1, further comprising:
at least one pair of rollers provided along said route of transfer; and
a roller driver to drive both of said pair of rollers to rotate in a document transfer direction.

10. An image forming device comprising the document reading device according to claim 1.

11. A method, executed by a computer, of controlling a document reading device including: a storage unit; a paper feed tray for placing a saddle-stitched document thereon in a saddle-stitched state; a transferring unit for transferring the document from said paper feed tray; a first reader and a second reader for respectively reading a front surface and a back surface of a document along a route of transfer through which said transferring unit transfers the document, the method comprising the steps of:
notifying of a manner how the saddle-stitch document is to be opened to be placed on said paper feed tray;
storing images of each page of the saddle-stitch document read by said first reader and said second reader in said storage unit; and
reconstructing the images stored in said storage unit by rearranging an order of the images.

12. The method of controlling the document reading device according to claim 11, the method further comprising the steps of:
acquiring either a total number of leaves or a total number of pages included in said saddle-stitch document; and
counting the number of transfer times of said saddle-stitch document through said route of transfer, wherein
in said notifying, the manner how the saddle-stitch document being transferred through said route of transfer is to be opened is updated and notified based on the total number of leaves or the total number of pages as well as on the number of transfer times.

13. The method of controlling the document reading device according to claim 11, said document reading device further including: a paper feed roller for feeding the document to said route of transfer; and a separation roller having a separation function of separating sheets of document one by one and to nip the document with said paper feed roller, the method further comprising the step of:
controlling an operation of said separation roller depending on a type of the document sent through said route of transfer, wherein
in said controlling of the operation of said separation roller,
the separation function of said separation roller is activated in a single-sheet mode for sending a single-sheet document along said route of transfer, and
the separation function of said separation roller is deactivated in a saddle-stitching mode for sending a saddle-stitch document along said route of transfer.

14. The method of controlling the document reading device according to claim 13, said document reading device further including: a separation roller driver for driving said separation roller; and a driver switch for switching a rotational direction transmitted from said separation roller driver to said separation roller, wherein
in said controlling of the operation of said separation roller, said driver switch is controlled such that said separation roller in said single-sheet mode rotates in a direction opposite of a direction for sending the document to said route of transfer, and said separation roller in said saddle-stitching mode rotates in the direction for sending the document to said route of transfer.

15. The method of controlling the document reading device according to claim 13, said document reading device further including: a separation roller driver for driving said separation roller; and a blocking unit for blocking transmission of driving force from said separation roller driver to said separation roller, wherein
in said controlling of the operation of said separation roller, said blocking unit is controlled such that said separation roller in said single-sheet mode is driven by said separation roller driver, and said separation roller in said saddle-stitching mode is prevented from being driven by said separation roller driver.

16. The method of controlling the document reading device according to claim 11, said document reading device further including: a registration unit provided along said route of transfer, for transferring the document with timing, the method further comprising the step of:
controlling an operation of said separation roller depending on a type of the document sent through said route of transfer, wherein
in said controlling of the operation of said separation roller,
said registration unit is caused to temporarily stop the document when transferring the document in a single-sheet mode for sending a single-sheet document along said route of transfer, and
said registration unit is prevented from stopping the document when transferring the document in a saddle-stitching mode for sending a saddle-stitch document along said route of transfer.

17. The method of controlling the document reading device according to claim 11, said route of transfer including a first route to send the document in a first direction and a second route provided downstream from said first route and to send the document in a second direction that is opposite of said first direction, said first reader and said second reader reading the document along said second route, said document reading device further including: an additional tray for sending said document to said second route without passing through said first route, the method further comprising the step of:
controlling a transfer mode of the document depending on a type of the document sent through said route of transfer, wherein
in said controlling of the transfer mode,
the document is transferred so that the document passes through said first route and said second route in a single-sheet mode for sending a single-sheet document along said route of transfer, and
the document is transferred so that the document passes through said second route from said additional tray in a saddle-stitching mode for sending a saddle-stitch document along said route of transfer.

18. The method of controlling the document reading device according to claim 11, said document reading device further including: a pickup roller for feeding the document placed on said paper feed tray to said route of transfer; and a transfer mechanism having a rotating body provided on said paper feed tray so as to face said pickup roller, the method further comprising the step of:
controlling said transfer mechanism depending on a type of the document sent through said route of transfer, wherein
in said controlling of the transfer mechanism,
said transfer mechanism is maintained in a stopped state in a single-sheet mode for sending a single-sheet document along said route of transfer, and
said transfer mechanism is driven in a transfer direction in a saddle-stitching mode for sending a saddle-stitch document along said route of transfer.

19. The method of controlling the document reading device according to claim 11, said document reading device further including: at least one pair of rollers provided along said route of transfer, the method further comprising the step of:
driving both of said pair of rollers to rotate in a document transfer direction.
